(19) United States
(12) Patent Application Publication
(10) Pub. No.: US 2006/0027140 A1
(43) Pub. Date: Feb. 9, 2006

(54) Multilayered interference pigments

(76) Inventors: Helge Bettina Kniess, Weiterstadt (DE); Peter Reynders, Griesheim (DE); Gerhard Pfaff, Muenster (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/190,054

(22) Filed: Jul. 27, 2005

(30) Foreign Application Priority Data
Jul. 27, 2004 (DE) 102004035769.2

(51) Int. Cl. C09D 11/00

(52) U.S. Cl. 106/415; 106/31.6; 106/31.9

(57) ABSTRACT

The present invention relates to multilayered interference pigments comprising a platelet-shaped substrate which is coated with alternating layers of materials of high and low refractive index, where the total thickness of the interference pigments is not greater than 1 μm. The present invention likewise relates to processes for the preparation of these pigments, in which a substrate is coated alternately with layers of materials of high and low refractive index, where the thicknesses of the layers of materials of high and low refractive index are selected in such a way that the total thickness of the interference pigments does not become greater than 1 μm, and to the use of these pigments in cosmetics, paints, coatings, plastics, films, in security printing, in security features in documents and identity cards, for coloring seed, for coloring foods or in medicament coatings, and for the preparation of pigment compositions and dry preparations.

The present invention relates to multilayered interference pigments comprising a platelet-shaped substrate which is coated with alternating layers of materials of high and low refractive index, where the total thickness of the interference pigments is not greater than 1 μm. The present invention likewise relates to processes for the preparation of these pigments, in which a substrate is coated alternately with layers of materials of high and low refractive index, where the thicknesses of the layers of materials of high and low refractive index are selected in such a way that the total thickness of the interference pigments does not become greater than 1 μm, and to the use of these pigments in cosmetics, paints, coatings, plastics, films, in security printing, in security features in documents and identity cards, for coloring seed, for coloring foods or in medicament coatings, and for the preparation of pigment compositions and dry preparations.

The use of luster or effect pigments having interference phenomena is widespread. Pigments of this type have become indispensable in automobile paints, decorative coatings of all types and in the coloring of plastics, in paints and printing inks, in particular inks for security printing, and in applications in decorative cosmetics. In the matrix surrounding them, these pigments ideally align parallel to the surface of the coating and exhibit their optical action through a complex interplay of interference, reflection and absorption of the incident light. A bright coloration, change between different colors depending on the viewing angle, so-called color flops, or changing brightness impressions are the focus of interest for the various applications.

Pigments of this type are generally prepared by coating platelet-shaped metallic or non-metallic substrates with metal-oxide or metal layers. In recent years, pigments have increasingly been developed which have a multilayered structure on the platelet-shaped support. This allows, in particular, color flops, in which the human eye perceives different hues depending on the viewing angle, to be set specifically. Most of these pigments are based on platelet-shaped substrates comprising metals or synthetic or natural phyllosilicates, such as mica, talc or glass.

The phyllosilicates have, in particular, the disadvantage that the thickness of the substrate varies in a broad range and cannot be set specifically, which results, even in the case of transparent substrates, in light transmission and reflection at the substrate occurring in a substantially uncontrollable manner and therefore not being utilizable in a targeted manner.

EP 0 08 388 discloses a platelet-shaped pigment which can consist, inter alia, of a silicon dioxide matrix which is coated with one or more layers of thin, transparent or semitransparent reflective layers of metal oxides or metals. The matrix here is preferably colored by addition of various colorants. Pigments of great color purity and high tinting strength are obtained whose hiding power is determined by the degree of coloring of the matrix. The thickness of the matrix can be set in a broad range here. No pigments which have more than one optically active layer on the substrate were described therein. These pigments therefore have the action of a pigment having a total of three optically active layers.

EP 1 025 168 (equivalent to U.S. Pat. No. 6,596,070 B1 incorporated by reference in its entirety herein) describes interference pigments based on multicoated substrates which have at least one layer sequence comprising a coating having a refractive index n≧2.0, a colorless coating having a refractive index n≦1.8 and a non-absorbent, high-refractive-index coating. The substrates have a preferred thickness of from 0.2 to 4.5 μm, and the thicknesses of the individual layers are preferably 20-350 nm for the high-refractive-index layer or 30-600 nm for the low-refractive-index layer and 20-350 nm for the non-absorbent, high-refractive-index coating. In particular, the large thickness of the low-refractive-index layer ensures that pigments having a relatively large total thickness are obtained. However, this is unfavorable for many applications, since the applicational properties of the pigments are impaired, a phenomenon which is described, for example, by P. Hoffmann, W. Duschek, Neue Effektpigmente [New Effect Pigments], in Berichtsband DFG 41, 1999, 50, 123-132. Thick pigments exhibit, for example, problems in the target parallel alignment in coating applications. The unfavorable geometry of the relatively thick pigment particles makes the desired alignment parallel to the surface in the binder system more difficult. Relatively thick pigment particles tend to arrange themselves at an angle to one another, so that the light no longer undergoes optimum specular reflection, and scattering effects reduce the specular luster. This gives rise to applicational disadvantages, such as, for example, an increased haze effect (reflection haze) and a poorer distinctness of image (DOI) of the pigment-containing coatings. Furthermore, coloristic disadvantages arise merely through the fact that the high mass of individual particles for the same sample weight results in a significantly smaller number of pigment particles in the coating application. This has disadvantageous effects on the hiding power, the luster and the overall color impression. The desired properties can therefore only be achieved poorly in the case of thick pigment particles.

JP 07-246366 discloses interference materials comprising a substrate, for example glass, and a multilayered structure comprising high- and low-refractive-index layers, with the main aim being the achievement of maximum reflectivity of the interference materials. Mention is made, for example, of a pigment having a total of nine layers on the substrate with a reflectivity of 99%. The layer thicknesses of the individual layers and of the substrates mean that, here too, relatively thick pigments are obtained which are unsuitable, for the above-mentioned reasons, for a number of applications. The theoretically achievable reflectivity is considerably reduced if the pigment geometry becomes increasingly cube-shaped, i.e. if the ratio of diameter and thickness approaches the value 1. The alignment of the platelet-shaped pigments is no longer ideal, and the specular luster is considerably reduced.

The object was therefore to find interference pigments which can be employed universally in a very wide variety of applications without exhibiting applicational disadvantages. At the same time, the pigments should exhibit interesting color effects, preferably with color flops when viewed at different viewing angles.

The above-mentioned object is achieved by pigments in accordance with the present invention. The present invention accordingly relates to multilayered interference pigments comprising a platelet-shaped substrate which is coated with alternating layers of materials of high and low refractive index, where the total thickness of the interference pigments is not greater than 1 μm.

The present invention likewise relates to processes for the preparation of these pigments, in which a substrate is coated alternately with layers of materials of high and low refractive index, where the thicknesses of the layers of materials of high and low refractive index are selected in such a way that the total thickness of the interference pigments does not become greater than 1 μm.

The pigments according to the invention have the advantage that they can be employed in a very wide variety of applications, where they exhibit improved applicational properties, for example a reduced haze effect and a better distinctness of image (DOI) in coating applications or better skin feel in cosmetic formulations.

At the same time, the interference pigments according to the invention enable the provision of a broad color range, which is frequently accompanied by the occurrence of color flops when viewed from different angles. In many cases, this color flop is also more pronounced and distinct than in the pigments from the prior art. Thus, the pigments according to the invention exhibit improved hiding power, greater specular luster and improved alignment of the pigment particles in the application medium. The defined layer sequence, taking into account the maximum total thickness of the pigments, thus results in interference pigments which combine crucial applicational advantages with improvements in the optical effects that can be achieved.

Owing to the advantageous properties, the interference pigments according to the invention are universally suitable for a large number of very different applications. The present invention accordingly also relates to the use of these pigments in cosmetics, paints, coatings, plastics, films, in security printing, in security features in documents and identity cards, for coloring seed, for coloring foods or in medicament coatings, and for the preparation of pigment compositions and dry preparations.

The pigments according to the invention are based on platelet-shaped substrates, for example mica or phyllosilicates. The platelet-shaped substrates are preferably synthetic flakes. Synthetic flakes include, inter alia, silicon dioxide, tin dioxide, zirconium dioxide, glass, aluminium oxide, titanium dioxide, magnesium fluoride and/or iron oxide. The substrate of the interference pigment according to the invention is preferably platelet-shaped silicon dioxide particles which have a uniform layer thickness and are preferably produced in accordance with the international application WO 93/08237 on a continuous belt by solidification and hydrolysis of a water-glass solution. “Uniform layer thickness” here is taken to mean a layer thickness tolerance of from 3 to 10%, preferably from 3 to 5%, of the total dry layer thickness of the particles. The platelet-shaped silicon dioxide particles are generally in amorphous form. Synthetic flakes of this type have an advantage over natural materials, such as, for example, mica, in that the layer thickness can be set with regard to the desired effects, and the layer thickness tolerance is limited. In this way, interference pigments in accordance with the present invention whose total thickness does not exceed 1 μm can be prepared in simplified form.

The diameter of the substrates is usually between 1 and 250 μm, preferably between 2 and 100 μm. Their thickness is between 100 and 600 nm, preferably from 200 to 500 nm and particularly preferably from 200 to 375 nm. The average aspect ratio of the platelet-shaped substrates, i.e. the ratio of the average length measurement value, which corresponds to the average diameter here, to the average thickness measurement value, is usually from 5 to 200, preferably from 20 to 150 and particularly preferably from 30 to 120.

The said substrates are coated in the pigments according to the invention with alternating layers of materials of high and low refractive index. Materials of high refractive index means materials in which the refractive index n is >1.8, and materials of low refractive index means materials in which the refractive index n is ≦1.8. The materials of high and low refractive index can be selected here from the group consisting of the metal oxides, metal oxide hydrates, metal suboxides, metals, metal fluorides, metal nitrides, metal oxynitrides, BiOCl and/or mixtures thereof. The materials of high and low refractive index are preferably metal oxides, metal oxide hydrates and/or mixtures thereof. Suitable metal oxides and metal oxide hydrates are all metal oxides or metal oxide hydrates to be applied as layers, such as, for example, aluminium oxide, aluminium oxide hydrate, iron oxide, tin oxide, cerium oxide, zinc oxide, zirconium oxide, chromium oxide, titanium oxide, in particular titanium dioxide, titanium oxide hydrate, and mixtures thereof, such as, for example, ilmenite or pseudobrookite. Metal suboxides which can be employed are, for example, the titanium suboxides. Examples of suitable metals are chromium, aluminium, nickel, silver, gold, titanium, copper or alloys, and a suitable metal fluoride is, for example, magnesium fluoride. Metal nitrides or metal oxynitrides which can be employed are, for example, the nitrides or oxynitrides of the metals titanium, zirconium and/or tantalum. The materials of high and low refractive index employed are preferably metal oxides, metals, metal fluorides and/or metal oxide hydrates and very particularly preferably metal oxides and/or metal oxide hydrates.

Particularly suitable materials of low refractive index are, for example, TiO₂, ZrO₂, ZnO, SnO₂, BiOCl and/or mixtures thereof. Particular preference is given to TiO₂. The thickness of these layers is in each case from about 10 to 300 nm and preferably from 30 to 200 nm or 20 to 100 nm.

Particularly suitable materials of high refractive index are, for example, SiO₂, SiO(OH)₂, Al₂O₃, AlO(OH), B₂O₃, MgF₂ and/or mixtures thereof. Particular preference is given to SiO₂. The thickness of the individual layers of these materials is between 20 and 100 nm, preferably from 20 to 80 nm.

The outer layer of the interference pigments according to the invention preferably consists of a high-refractive-index material, in particular TiO₂. Starting from this condition, certain rules arise for the preferred construction of the pigments according to the invention. If the substrate consists of a high-refractive-index material, such as, for example, TiO₂ or iron oxide, it is coated with a layer of a material of low refractive index and a layer of a material of high refractive index. In this way, a pigment having a total of five layers, including the substrate, is obtained. For the purposes of the present invention, it is assumed here that the coating preferably takes place in a sheathing manner, i.e. both the substrate and all subsequent coated intermediate stages are coated on each side of the flakes in each coating step. Besides a pigment having five layers, a pigment having a total of nine layers is also conceivable within the scope of the present invention, so long as the condition that the total thickness of the pigments does not become greater than 1 μm is satisfied.

The substrate material is preferably a material of low refractive index, in particular SiO₂. In this case, pigments having three and seven layers satisfy the condition that the outer layer comprises a high-refractive-index material. The interference pigments according to the invention preferably comprise a total of seven layers, including the substrate. In particular in the case of pigments having seven layers, the thickness of the individual layers is important in order that the basic condition that the total thickness of the pigments is not greater than 1 μm remains satisfied. In this connection, the thickness of the layers of materials of low refractive index is of particular importance. In the course of the present invention, it has been achieved to set the thickness of the layers of materials of low refractive index, while retaining or optimizing the coloristic properties, in such a way that the total thickness of the pigments according to the invention is less than that from the prior art. By means of the present invention, it is thus possible to provide thinner pigments having improved optical properties. This has an advantageous effect both on the applicational properties and also on the preparation costs of the pigments. The latter can be reduced through the lower material cost and time expenditure during preparation.

In the case of the above-mentioned pigments according to the invention having a total of seven layers, a total of two sheathed layers of materials of high refractive index are present. These layers can consist of identical or different materials and have identical or different layer thicknesses. They preferably consist of identical materials, in particular of TiO₂. Pigments which are very particularly preferred in the present invention accordingly have the following structure: TiO₂/SiO₂/TiO₂/substrate (SiO₂)/TiO₂/SiO₂/TiO₂

In a further embodiment of the present invention, the effect pigments according to the invention may furthermore be provided with an additional organic coating as outer layer. Examples of such coatings are given, for example, in EP 0 632 109, U.S. Pat. No. 5,759,255, DE 43 17 019, DE 39 29 423, DE 32 35 017, EP 0 492 223, EP 0 342 533, EP 0 268 918, EP 0 141 174, EP 0 764 191, WO 98/13426 or EP 0 465 805, the disclosure content of which is hereby entirely incorporated by reference. Effect pigments comprising this organic coating, for example comprising organosilanes or organotitanates or organozirconates, additionally, besides the above-mentioned improved optical properties, exhibit increased stability to weathering influences, such as, for example, moisture and light, which is of particular interest for industrial coatings and in the automobile sector. When such a coating is present, the pigments still have a total thickness which does not exceed 1 μm, including the organic coating.

The present invention likewise relates to processes for the preparation of the interference pigments according to the invention, in which a substrate is coated alternately with layers of materials of high and low refractive index, where the thicknesses of the layers of materials of high and low refractive index are selected in such a way that the total thickness of the interference pigments does not become greater than 1 μm.

The coating with layers of materials of low refractive index is preferably carried out in such a way that the thickness of the layers is between 20 and 100 nm. In this way, it is ensured in the processes according to the invention that the total thickness does not exceed the requisite value.

The coating with layers of materials of high and low refractive index can be carried out by wet-chemical methods, by sol-gel processes and/or by CVD or PVD processes.

The processes according to the invention for the preparation of interference pigments are preferably wet-chemical processes, in which the known wet-chemical coating technologies developed for the preparation of pearlescent pigments can be used, these being described, for example, in the following publications:
DE 14 67 468, DE 19 59 988, DE 20 09 566, DE 22 14 545, DE 22 15 191, DE 22 44 298, DE 23 13 331, DE 25 22 572, DE 31 37 808, DE 31 37 809, DE 31 51 343, DE 31 51 354, DE 31 51 355, DE 32 11 602, DE 32 35 017.

For the coating, the platelet-shaped substrate is suspended in water and coated alternately, preferably a number of times, with a metal oxide, metal oxide hydrate, metal suboxide, metal, metal fluoride, metal nitride, metal oxynitride and/or mixtures thereof of high refractive index and with a metal oxide, metal oxide hydrate, metal suboxide, metal, metal fluoride, metal nitride, metal oxynitride and/or mixtures thereof of low refractive index by addition and precipitation of the corresponding inorganic metal compounds, where the pH necessary for the precipitation of the respective metal oxide, metal oxide hydrate, metal suboxide, metal, metal fluoride, metal nitride, metal oxynitride is set and kept constant by simultaneous addition of acid or base, and the coated substrate is subsequently separated off from the aqueous suspension, dried and optionally calcined, and where the layer thicknesses of the individual layers are set in such a way that, after drying and optionally calcination, the thickness of the pigment is not greater than 1 μm.

The calcination temperature here can be optimized with respect to the coating present in each case. In general, however, the calcination temperature is between 250 and 1000° C., in particular between 350 and 900° C. The pigments may also be separated off after application of each individual layer, dried and optionally calcined before they are re-dispersed for application of the next layer.

If the material of high refractive index is TiO₂, the process described in U.S. Pat. No. 3,553,001 is preferably employed for application of these layers. In this process, an aqueous solution of an inorganic titanium salt is slowly added to a suspension, heated to about 50-100° C., in particular 70-80° C., of the platelet-shaped, optionally already pre-coated substrates, and the pH is kept substantially constant at from 0.5 to 5, in particular from about 1.5 to 2.5, by simultaneous metered addition of a base. As soon as the desired layer thickness of the TiO₂ oxide hydrate has been reached, the addition of the titanium salt solution and of the base is stopped. This process is also known as the titration process and has the special feature that there is no excess of titanium salt, but instead only an amount as is necessary for uniform coating with the hydrated TiO₂ and can also be taken up by the surface of the substrate to be coated is always provided per time unit. The solution therefore contains no hydrated titanium dioxide particles which are not deposited on the surface to be coated.

If the material of low refractive index is silicon dioxide, the following process is preferably used for application of the corresponding layer or layers:

A sodium water-glass solution is added to a suspension, heated to from about 50 to 100° C., in particular from 70 to 80° C., of the already mono- or multicoated substrate. At the same time, the pH is kept constant at from 4 to 10, preferably from 6.5 to 8.5, by addition of 10% hydrochloric acid. When the addition of the water-glass solution is complete, the mixture is stirred for about a further 30 minutes. Alternatively, layers of SiO₂ can also be produced by sol-gel processes, in which corresponding precursors, for example tetraethoxysilane, are employed.

In principle, CVD or PVD processes for the coating of particles, in particular with metals, are also suitable for the preparation of the pigments according to the invention. It is necessary in this case that the substrate be kept in uniform motion during the vapor-deposition process in order that homogeneous coating of all particle surfaces is ensured.

In addition, an organic coating can additionally be applied as outer layer in a process likewise in accordance with the invention. Examples of coating processes of this type are given, inter alia, in EP 0 632 109, U.S. Pat. No. 5,759,255, DE 43 17 019, DE 39 29 423, DE 32 35 017, EP 0 492 223, EP 0 342 533, EP 0 268 918, EP 0 141 174, EP 0 764 191, WO 98/13426 or EP 0 465 805. Examples of organic coatings and the advantages associated therewith have already been described above under the synthesis of the pigments according to the invention. The process step of application of the organic coating can be carried out directly after the other steps of the process according to the invention. The substances applied in this step merely make up a proportion by weight of from 0.1 to 5% by weight, preferably from 0.5 to 3% by weight, of the pigment as a whole.

The interference pigments according to the invention are versatile and can be employed in many areas. Accordingly, the present invention likewise relates to the use of the pigments according to the invention in cosmetics, paints, coatings, plastics, films, in security printing, in security features in documents and identity cards, for coloring seed, for coloring foods or in medicament coatings, and for the preparation of pigment compositions and dry preparations.

In the case of cosmetics, the interference pigments according to the invention are particularly suitable for products and formulations in decorative cosmetics, such as, for example, nail varnishes, coloring powders, lipsticks or eyeshadows, soaps, toothpastes, etc. The interference pigments according to the invention can of course also be combined in the formulations with cosmetic raw materials and auxiliaries of all types. These include, inter alia, oils, fats, waxes, film formers, preservatives and auxiliaries which generally determine applicational properties, such as, for example, thickeners and rheological additives, such as, for example, bentonites, hectorites, silicon dioxide, Ca silicates, gelatine, high-molecular-weight carbohydrates and/or surface-active auxiliaries, etc. The formulations comprising interference pigments according to the invention can belong to the lipophilic, hydrophilic or hydrophobic type. In the case of heterogeneous formulations with discrete aqueous and non-aqueous phases, the particles according to the invention may be present in in each case only one of the two phases or alternatively distributed over both phases.

The pH values of the aqueous formulations can be between 1 and 14, preferably between 2 and 11 and particularly preferably between 5 and 8. No limits are set for the concentrations of the interference pigments according to the invention in the formulation. They can be—depending on the application—between 0.001 (rinse-off products, for example shower gels) and 99% (for example luster-effect articles for particular applications). The interference pigments according to the invention may furthermore also be combined with cosmetic active ingredients. Suitable active ingredients are, for example, insect repellents, UV A/BC protection filters (for example OMC, B3, MBC), anti-ageing active ingredients, vitamins and derivatives thereof (for example vitamin A, C, E, etc.), self-tanning agents (for example DHA, erythrulose, inter alia), and further cosmetic active ingredients, such as, for example, bisabolol, LPO, ectoine, emblica, allantoin, bioflavonoids and derivatives thereof.

In the case of the use of the interference pigments in paints and coatings, all areas of application known to the person skilled in the art are possible, such as, for example, powder coatings, automobile paints, printing inks for gravure, offset, screen or flexographic printing, and for coatings in outdoor applications. The paints and coatings here can be, for example, radiation-curing, physically drying or chemically curing. A multiplicity of binders is suitable for the preparation of printing inks or liquid surface coatings, for example based on acrylates, methacrylates, polyesters, polyurethanes, nitrocellulose, ethylcellulose, polyamide, polyvinyl butyrate, phenolic resins, maleic resins, starch or polyvinyl alcohol, amino resins, alkyd resins, epoxy resins, polytetrafluoroethylene, polyvinylidene fluorides, polyvinyl chloride or mixtures thereof, in particular water-soluble grades. The surface coatings can be powder coatings or water- or solvent-based coatings, where the choice of the coating constituents is part of the general knowledge of the person skilled in the art. Common polymeric binders for powder coatings are, for example, polyesters, epoxides, polyurethanes, acrylates or mixtures thereof.

In addition, the interference pigments according to the invention can be used in films and plastics, for example in agricultural sheeting, infrared-reflective foils and sheets, gift foils, plastic containers and moldings for all applications known to the person skilled in the art. Suitable plastics for the incorporation of the interference pigments according to the invention are all common plastics, for example thermosets or thermoplastics. The description of the possible applications and the plastics which can be employed, processing methods and additives are given, for example, in RD 472005 or in R. Glausch, M. Kieser, R. Maisch, G. Pfaff, J. Weitzel, Perlglanzpigmente [Pearlescent Pigments], Curt R. Vincentz Verlag, 1996, 83 ff., the disclosure content of which is also incorporated herein.

In addition, the interference pigments according to the invention are also suitable for use in security printing and in security-relevant features for, for example, forgery-proof cards and identity papers, such as, for example, entry tickets, personal identity cards, banknotes, checks and check cards, and for other forgery-proof documents. In the area of agriculture, the interference pigments can be used for coloring seed and other starting materials, in addition in the foods sector for pigmenting foods. The interference pigments according to the invention can likewise be employed for pigmenting coatings in medicaments, such as, for example, tablets or dragees.

The interference pigments according to the invention are likewise suitable in the above-mentioned areas of application for use in blends with organic dyes and/or pigments, such as, for example, transparent and opaque white, colored and black pigments, and with platelet-shaped iron oxides, organic pigments, holographic pigments, LCPs (liquid crystal polymers) and conventional transparent, colored and black luster pigments based on metal oxide-coated flakes based on mica, glass, Al₂O₃, Fe₂O₃, SiO₂, etc. The interference pigments according to the invention can be mixed in any ratio with commercially available pigments and fillers.

Fillers which may be mentioned are, for example, natural and synthetic mica, nylon powder, pure or filled melamine resins, talc, glasses, kaolin, oxides or hydroxides of aluminium, magnesium, calcium, zinc, BiOCl, barium sulfate, calcium sulfate, calcium carbonate, magnesium carbonate, carbon, and physical or chemical combinations of these substances. There are no restrictions with respect to the particle shape of the filler. It can be, for example, platelet-shaped, spherical or needle-shaped in accordance with requirements.

The interference pigments according to the invention are furthermore suitable for the preparation of flowable pigment compositions and dry preparations comprising one or more particles according to the invention, binders and optionally one or more additives. Dry preparations is also taken to mean preparations which comprise from 0 to 8% by weight, preferably from 2 to 8% by weight, in particular from 3 to 6% by weight, of water and/or a solvent or solvent mixture. The dry preparations are preferably in the form of pellets, granules, chips, sausages or briquettes and have particle sizes of 0.2-80 mm. The dry preparations are used, in particular, in the preparation of printing inks and in cosmetic formulations.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius and, all parts and percentages are by weight, unless otherwise indicated.

### EXAMPLES

### Example 1

100 g of SiO₂ flakes having a mean layer thickness of 350 nm are suspended in 1.9 l of demineralized water with stirring and heated to 75° C. The pH of the suspension is adjusted to 2.2 using 18% hydrochloric acid. 524 g of 30% titanium tetrachloride solution (prepared by dissolution of 262 g of titanium tetrachloride solution (w=60% by weight) in 262 g of demineralized water) are metered in, during which the pH is kept constant by simultaneous dropwise addition of 32% sodium hydroxide solution. When the addition is complete, the mixture is stirred for a further 15 minutes. The pH of the suspension is subsequently adjusted to 7.5 using 32% sodium hydroxide solution, and the mixture is stirred for a further 15 minutes. A sodium water-glass solution (116 g of sodium water-glass solution comprising 27% by weight of SiO₂, dissolved in 116 g of dematerialized water) is then added dropwise, during which the pH is kept constant at 7.5 by simultaneous metered addition of 18% hydrochloric acid. When the addition is complete, the mixture is stirred for a further 30 minutes. The pH of the suspension is then adjusted to 2.2 using 18% hydrochloric acid, the mixture is stirred for a further 30 minutes, and 641 g of 30% titanium tetrachloride solution are added dropwise. The pH is kept constant at 2.2 by addition of 32% sodium hydroxide solution. The mixture is again stirred for a further 15 minutes. The product is filtered off, washed, dried, calcined at 800° C. and sieved through a 100 μm sieve.

An interference pigment having the following structure is obtained:
TiO₂ (98 nm)/SiO₂ (60 nm)/TiO₂ (80 nm)/substrate (SiO₂) (350 nm)/TiO₂ (80 nm)/SiO₂ (60 nm)/TiO₂ (98 nm)
   The total thickness of the pigment is 0.826 μm.

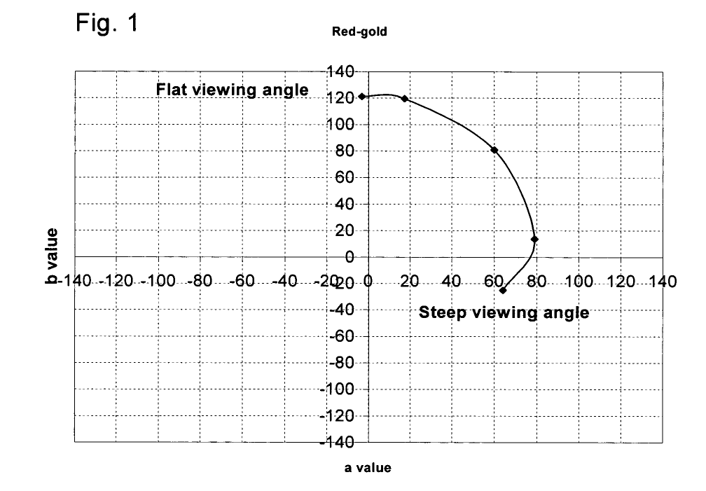

Paint cards are prepared by incorporation into nitrocellulose lacquer and are measured coloristically. The corresponding Hunter L,a,b color diagram is shown in FIG. 1. It shows a color flop from red to gold from a steep to flat viewing angle.

### Example 2

100 g of SiO₂ flakes having a mean layer thickness of 450 nm are suspended in 1.9 l of demineralized water with stirring and heated to 75° C. The pH of the suspension is adjusted to 2.2 using 18% hydrochloric acid. 458 g of 30% titanium tetrachloride solution (prepared by dissolution of 229 g of titanium tetrachloride solution (w=60% by weight) in 229 g of demineralized water) are metered in, during which the pH is kept constant by simultaneous dropwise addition of 32% sodium hydroxide solution. When the addition is complete, the mixture is stirred for a further 15 minutes. The pH of the suspension is subsequently adjusted to 7.5 using 32% sodium hydroxide solution, and the mixture is stirred for a further 15 minutes. A sodium water-glass solution (97 g of sodium water-glass solution comprising 27% by weight of SiO₂, dissolved in 97 g of demineralized water) is then added dropwise, during which the pH is kept constant at 7.5 by simultaneous metered addition of 18% hydrochloric acid. When the addition is complete, the mixture is stirred for a further 30 minutes. The pH of the suspension is then adjusted to 2.2 using 18% hydrochloric acid, the mixture is stirred for a further 30 minutes, and 608 g of 30% titanium tetrachloride solution are added dropwise. The pH is kept constant at 2.2 by addition of 32% sodium hydroxide solution. The mixture is again stirred for a further 15 minutes. The product is filtered off, washed, dried, calcined at 800° C. and sieved through a 100 μm sieve.

An interference pigment having the following structure is obtained:
TiO₂ (93 nm)/SiO₂ (50 nm)/TiO₂ (70 nm)/substrate (SiO₂) (450 nm)/TiO₂ (70 nm)/SiO₂ (50 nm)/TiO₂ (93 nm)
   The total thickness of the pigment is 0.876 μm.

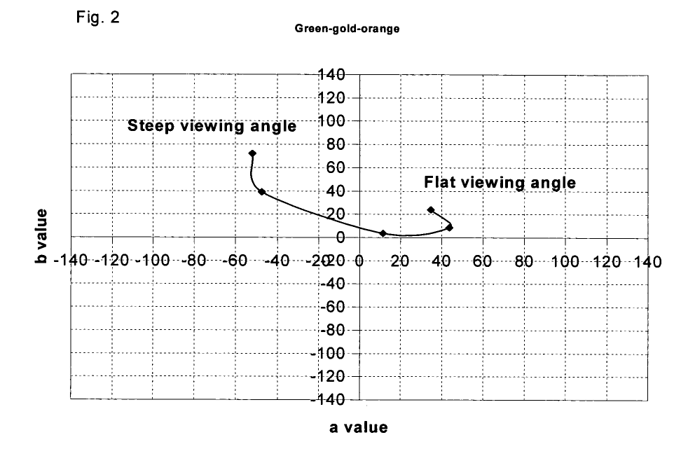

Paint cards are prepared by incorporation into nitrocellulose lacquer and are measured coloristically. The corresponding Hunter L,a,b color diagram is shown in FIG. 2. It shows a color flop from green-gold to orange from a steep to flat viewing angle.

### Example 3

100 g of SiO₂ flakes having a mean layer thickness of 320 nm are suspended in 1.9 l of demineralized water with stirring and heated to 75° C. The pH of the suspension is adjusted to 2.2 using 18% hydrochloric acid. 850 g of 30% titanium tetrachloride solution (prepared by dissolution of 425 g of titanium tetrachloride solution (w=60% by weight) in 425 g of demineralized water) are metered in, during which the pH is kept constant by simultaneous dropwise addition of 32% sodium hydroxide solution. When the addition is complete, the mixture is stirred for a further 15 minutes. The pH of the suspension is subsequently adjusted to 7.5 using 32% sodium hydroxide solution, and the mixture is stirred for a further 15 minutes. A sodium water-glass solution (77 g of sodium water-glass solution comprising 27% by weight of SiO₂, dissolved in 77 g of demineralized water) is then added dropwise, during which the pH is kept constant at 7.5 by simultaneous metered addition of 18% hydrochloric acid. When the addition is complete, the mixture is stirred for a further 30 minutes. The pH of the suspension is then adjusted to 2.2 using 18% hydrochloric acid, the mixture is stirred for a further 30 minutes, and 687 g of 30% titanium tetrachloride solution are added dropwise. The pH is kept constant at 2.2 by addition of 32% sodium hydroxide solution. The mixture is again stirred for a further 15 minutes. The product is filtered off, washed, dried, calcined at 800° C. and sieved through a 100 μm sieve.

An interference pigment having the following structure is obtained:
TiO₂ (105 nm)/SiO₂ (40 nm)/TiO₂ (130 nm)/substrate (SiO₂) (320 nm)/TiO₂ (40 nm)/SiO₂ (130 nm)/TiO₂ (105 nm)
   The total thickness of the pigment is 0.87 μm.

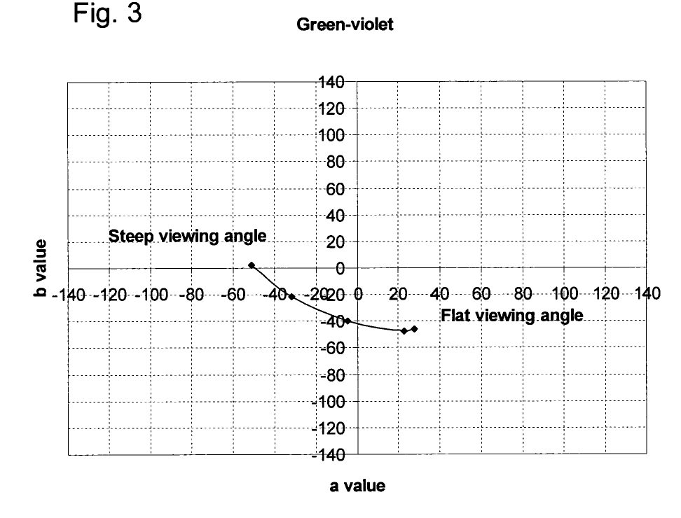

Paint cards are prepared by incorporation into nitrocellulose lacquer and are measured coloristically. The corresponding Hunter L,a,b color diagram is shown in FIG. 3. It shows a color flop from green to violet from a steep to flat viewing angle.

### Example 4

100 g of SiO₂ flakes having a mean layer thickness of 220 nm are suspended in 1.9 l of demineralized water with stirring and heated to 75° C. The pH of the suspension is adjusted to 2.2 using 18% hydrochloric acid. 262 g of 30% titanium tetrachloride solution (prepared by dissolution of 131 g of titanium tetrachloride solution (w=60% by weight) in 131 g of demineralized water) are metered in, during which the pH is kept constant by simultaneous dropwise addition of 32% sodium hydroxide solution. When the addition is complete, the mixture is stirred for a further 15 minutes. The pH of the suspension is subsequently adjusted to 7.5 using 32% sodium hydroxide solution, and the mixture is stirred for a further 15 minutes. A sodium water-glass solution (135 g of sodium water-glass solution comprising 27% by weight of SiO₂, dissolved in 135 g of demineralized water) is then added dropwise, during which the pH is kept constant at 7.5 by simultaneous metered addition of 18% hydrochloric acid. When the addition is complete, the mixture is stirred for a further 30 minutes. The pH of the suspension is then adjusted to 2.2 using 18% hydrochloric acid, the mixture is stirred for a further 30 minutes, and 654 g of 30% titanium tetrachloride solution are added dropwise. The pH is kept constant at 2.2 by addition of 32% sodium hydroxide solution. The mixture is again stirred for a further 15 minutes. The product is filtered off, washed, dried, calcined at 800° C. and sieved through a 100 μm sieve.

An interference pigment having the following structure is obtained:
TiO₂ (100 nm)/SiO₂ (70 nm)/TiO₂ (40 nm)/substrate (SiO₂) (220 nm)/TiO₂ (40 nm)/SiO₂ (70 nm)/TiO₂ (100 nm)
   The total thickness of the pigment is 0.64 μm.

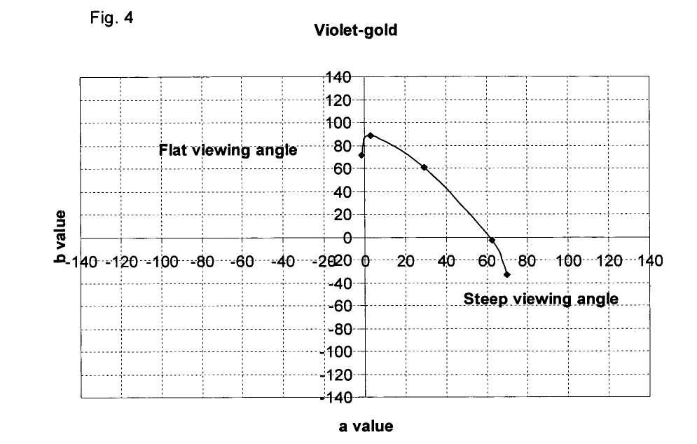

Paint cards are prepared by incorporation into nitrocellulose lacquer and are measured coloristically. The corresponding Hunter L,a,b color diagram is shown in FIG. 4. It shows a color flop from violet to gold from a steep to flat viewing angle.

### Comparative Example

100 g of SiO₂ flakes having a mean layer thickness of 500 nm are suspended in 1.9 l of demineralized water with stirring and heated to 75° C. The pH of the suspension is adjusted to 2.2 using 18% hydrochloric acid. 412 g of 30% titanium tetrachloride solution (prepared by dissolution of 206 g of titanium tetrachloride solution (w=60% by weight) in 206 g of demineralized water) are metered in, during which the pH is kept constant by simultaneous dropwise addition of 32% sodium hydroxide solution. When the addition is complete, the mixture is stirred for a further 15 minutes. The pH of the suspension is subsequently adjusted to 7.5 using 32% sodium hydroxide solution, and the mixture is stirred for a further 15 minutes. A sodium water-glass solution (270 g of sodium water-glass solution comprising 27% by weight of SiO₂, dissolved in 270 g of demineralized water) is then added dropwise, during which the pH is kept constant at 7.5 by simultaneous metered addition of 18% hydrochloric acid. When the addition is complete, the mixture is stirred for a further 30 minutes. The pH of the suspension is then adjusted to 2.2 using 18% hydrochloric acid, the mixture is stirred for a further 30 minutes, and 968 g of 30% titanium tetrachloride solution are added dropwise. The pH is kept constant at 2.2 by addition of 32% sodium hydroxide solution. The mixture is again stirred for a further 15 minutes. The product is filtered off, washed, dried, calcined at 800° C. and sieved through a 100 μm sieve.

An interference pigment having the following structure is obtained:
TiO₂ (148 nm)/SiO₂ (140 nm)/TiO₂ (63 nm)/substrate (SiO₂) (500 nm)/TiO₂ (63 nm)/SiO₂ (140 nm)/TiO₂ (148 nm)
   The total thickness of the pigment is 1.2 μm.

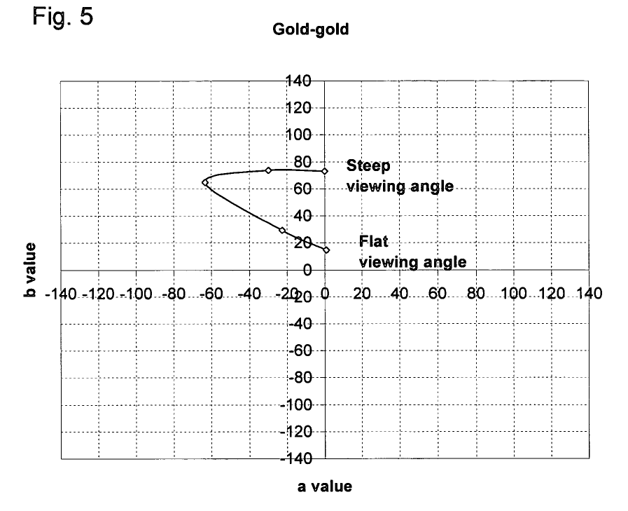

Paint cards are prepared by incorporation into nitrocellulose lacquer and are measured coloristically. The corresponding Hunter L,a,b color diagram is shown in FIG. 5. It shows only a minimal color change from gold via green-gold back to gold which is scarcely perceptible to the eye from a steep to flat viewing angle.

The entire disclosure[s] of all applications, patents and publications, cited herein and of corresponding German application No. 102004035769.2, filed Jul. 27, 2004, is incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A multilayered interference pigment, comprising a platelet-shaped substrate which is coated with alternating layers of materials of high and low refractive index, said interference pigment having a total thickness of not greater than 1 μm.

2. The interference pigment according to claim 1, wherein the substrate is a synthetic flake.

3. The interference pigment according to claim 2, wherein the synthetic flake is silicon dioxide, glass, aluminium oxide, tin dioxide, zirconium dioxide, titanium dioxide, magnesium fluoride, iron oxide or mixtures thereof.

4. The interference pigment according to claim 1, wherein the substrate has a diameter of 1 to 250 μm, and a thickness of 100 to 600 nm.

5. The interference pigment according to claim 1, wherein the materials of high and low refractive index are metal oxides, metal oxide hydrates, metal suboxides, metals, metal fluorides, metal nitrides, metal oxynitrides or mixtures thereof.

6. The interference pigment according to claim 5, wherein the material of high refractive index is TiO₂, ZrO₂, ZnO, SnO₂, BiOCl or mixtures thereof.

7. The interference pigment according to claim 5, wherein the material of low refractive index is SiO₂, SiO(OH)₂, Al₂O₃, AlO(OH), B₂O₃, MgF₂ or mixtures thereof.

8. The interference pigment according to claim 1, wherein the thickness of each of the layers of low refractive index is 20 to 100 nm.

9. The interference pigment according to claim 1, having a total of seven layers, including the substrate.

10. The interference pigment according to claim 1, wherein an organic coating is additionally applied to the interference pigments.

11. A process for the preparation of an interference pigment according to claim 1, comprising alternately coating a substrate with layers of materials of high and low refractive index, where the thicknesses of the layers of materials of high and low refractive index are selected in such a way that the total thickness of the interference pigments does not become greater than 1 μm.

12. A process according to claim 11, wherein coating with layers of materials of low refractive index is carried out in such a way that the thickness of the layers is 20 to 100 nm.

13. A process according to claim 11, wherein coating with layers of materials of high and low refractive index is carried out by wet-chemical methods, by sol-gel processes by CVD or PVD processes, or a combination thereof.

14. In cosmetic, paint, coating, plastic, film, security feature in a document or identity card, colored seed, colored food or medicament coating, or dry preparation comprising a pigment, the improvement wherein the pigment is one according to claim 1.

15. A pigment composition comprising a pigment and conventional excipients, wherein the pigment is one according to claim 1.

16. The pigment according to claim 1, in the form of a dry preparation.

17. A process for the preparation of a composition according to claim 15, comprising blending the pigment and excipient, and optionally drying.
